(19) United States
(12) Patent Application Publication
(10) Pub. No.: US 2020/0257684 A1
(43) Pub. Date: Aug. 13, 2020

(54) HIGHER-ORDER DATA SKETCHING FOR AD-HOC QUERY ESTIMATION

(71) Applicant: Red Hat, Inc., Raleigh, NC (US)

(72) Inventors: Erik Jordan Erlandson, Phoenix, AZ (US); William Christian Benton, Madison, WI (US)

(21) Appl. No.: 16/269,891

(22) Filed: Feb. 7, 2019

(51) Int. Cl. G06F 16/2458; G06F 16/22; G06F 7/505; G06F 16/901

(52) U.S. Cl. CPC G06F 16/2462; G06F 16/9024; G06F 7/5055; G06F 16/2255

(57) ABSTRACT

Technology for using a nested probabilistic data structure to determine properties of a data set. An example method may involve: receiving a data item comprising a first and second item values; accessing a first probabilistic data structure comprising elements with references to a plurality of second probabilistic data structures; evaluating the first probabilistic data structure to identify a set of the second probabilistic data structures, wherein the evaluating comprises applying a set of hash functions to the first item value to generate hash values indicating the set of second probabilistic data structures corresponding to the first item value; evaluating one of the second probabilistic data structures in view of the second item value to identify a set of elements of the second probabilistic data structure corresponding to the second item value; and updating the set of elements of the second probabilistic data structure to represent the data item.

### TECHNICAL FIELD

The present disclosure generally relates to the use of a probabilistic data structure to represent a set of data items, and more specifically relates to the creation and use of a nested probabilistic data structure to estimate properties of a data set.

### BACKGROUND

Computer systems process a large amount of events and often monitor the occurrences of particular events. The computer systems may track events using a variety of traditional data structures, such as indexes or tables, and the size of the traditional data structures will depend on the size of the set and the number of predefined events being tracked. When the set is very large with many predefined events, the traditional data structure may grow very large. The size and subsequent growth of the traditional data structures is often linearly or exponentially related to the size of the set and may result in consuming a very large amount of storage space.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level diagram of an example computing device that includes one or more probabilistic data structures in accordance with one or more aspects of the present disclosure;

FIG. 2 depicts a high-level diagram of an example computing device evaluating the one or more probabilistic data structures in view of a data item in accordance with one or more aspects of the present disclosure;

FIG. 3 depicts a block diagram of a computer system that includes one or more components and modules in accordance with one or more aspects of the present disclosure.

FIG. 4 depicts a flow diagram of an example method for updating one or more probabilistic data structures in accordance with one or more aspects of the present disclosure;

FIG. 5 depicts a flow diagram of an example method for querying one or more probabilistic data structures in accordance with one or more aspects of the present disclosure;

FIG. 6 depicts a block diagram of a computer device operating in accordance with one or more aspects of the present disclosure.

FIG. 7 depicts a block diagram of a computer system operating in accordance with one or more aspects of the present disclosure.

### DETAILED DESCRIPTION

Modern computers often use probabilistic data structures to reduce the amount of storage space consumed to track properties of a data set. The probabilistic data structure may represent the data set and may be used to estimate how many instances of a particular data item are in the set. In one example, the probabilistic data structure may be a basic sketch that is the same or similar to a count-min sketch or bloom filter and may represent properties of predefined data items in the set. The basic sketch may be selected and configured based on the data items being represented and often requires the data items being tracked be predefined (e.g., user identifies which keywords to track). The basic sketch may also not handle data items with multiple keys efficiently. For example, a data item that includes multiple key values may be added to the basic sketch multiple times using each of the multiple keys.

Aspects of the present disclosure address the above and other deficiencies by providing technology that uses a nested probabilistic data structure to represent properties of a set of data items. The properties may be related to the size, frequency, or intersections of the set or one or more particular data items within the set. The technology may involve building a nested probabilistic data structure that includes an outer probabilistic data structure and multiple inner probabilistic data structures. Each of the probabilistic data structures may include a set of elements that correspond to each data item in the set. Elements of the outer probabilistic data structure may reference inner probabilistic data structures.

The technology disclosed herein may update and query the nested probabilistic data structure to determine the properties. An example method for evaluating the nested probabilistic data structure may involve receiving a data item that includes multiple item values (e.g., multiple keywords). The data item and multiple item values may be predefined or may be unrecognized to the system prior to their receipt. In one example, the technology may evaluate an outer probabilistic data structure using a first item value and an inner probabilistic data structures using a second item value. The second item value may be the same or different from the first item value and in one example may include one or more item values (e.g., include all the keywords). Each evaluation may involve applying a set of hash functions to the respective item value to generate a set of hashes. Each hash may be used to identify a particular element of one of the probabilistic data structures. The element may include a value (e.g., accumulator) and the value may be a reference to another probabilistic data structure (e.g., pointer to an inner count-min sketch), a counter (e.g., integer), a flag (e.g., bit), other value, or a combination thereof. The technology may evaluate multiple layers of probabilistic data structures to derive a set of elements that correspond to the particular data item. The set of elements may then be queried to determine a property for the data item or may be updated to represent the addition of the data item to the nested probabilistic data structure.

Systems and methods described herein include technology for using nested probabilistic data structures to represent and calculate properties of large data sets. Aspects of the technology may enable the nested probabilistic data structure to represent any data items and not just those that have been previously identified to be tracked (e.g., predicates). The technology may dynamically add any and all recognized and unrecognized data items in an ad hoc manner. The probabilistic data structure may also be queried in an ad hoc manner to determine properties related to the previously unrecognized data items. In addition, aspects of the technology may enable the nested probabilistic data structure to represent properties more accurately then non-nested probabilistic data structures (i.e., basic sketches). For example, a single data item that includes multiple values may be added to the nested probabilistic data structure once using the multiple different values as keys. This may enable the nested probabilistic data structure to more accurately estimate properties that involve the intersection between the different item values (e.g., items that include both keyword A and B). In addition, aspects of the present disclosure may reduce the amount of storage space necessary to represent properties of data sets. The nested probabilistic data structure may be capable of representing the same properties as a more traditional non-probabilistic data structure (e.g., hash table or index) but may do so in a more spatially efficient manner and therefore consume less storage space. For example, the nested probabilistic data structure may consume storage space with a growth rate that is sub-linear compared to the size of the set. This may be much less than a traditional non-probabilistic data structure that consumes storage space at a rate that is linear or exponential compared to the size of the set.

The example systems and methods described herein discuss a nested probabilistic data structure that includes multiple count-min sketches. In other examples, different types of probabilistic data structures may be used such as bloom filters, hyperloglog, other probabilistic data structures, or a combination thereof. Various aspects of the above referenced methods and systems are described in details herein below by way of examples, rather than by way of limitation.

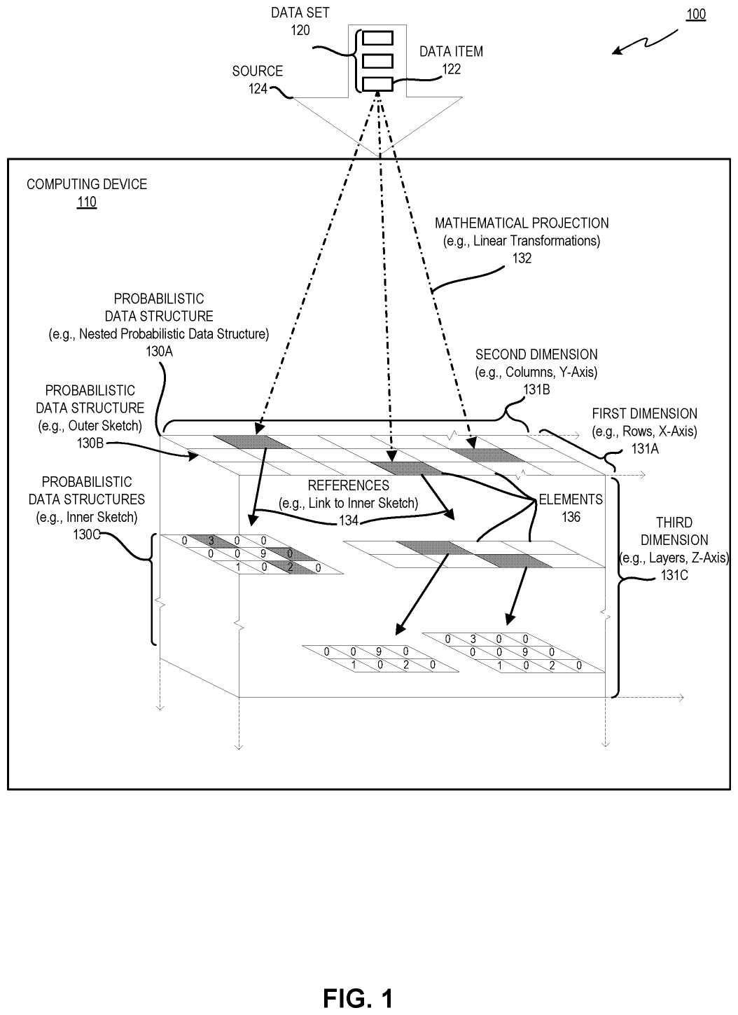

FIG. 1 illustrates an example system 100 that includes a nested probabilistic data structure representing a set of data items, in accordance with an implementation of the disclosure. System 100 may include one or more computing devices 110, data sets 120, and probabilistic data structures 130A-C.

Computing device 110 may be any server computer, a personal computer, desktop computer, laptop computer, mobile phone, tablet, other computing device, or a combination thereof. In some implementations, computing device 110 may be referred to as a “computer,” “server” other variation, or a combination thereof. In the example shown in FIG. 1, computing device 110 may receive data set 120 and process data set 120 to update or query probabilistic data structure 130.

Data set 120 may be a set of one or more data items 122 that are received from one or more sources. Data item 122 may include any sequence of binary data, numeric data (e.g., numbers, integers), character data (e.g., text), other data, or a combination thereof. The data items may be related to, associated with, or represent one or more computing objects, computing events, or a combination thereof. The computing objects may include database objects (e.g., entries, records, tables, schemas, databases), filesystem objects (e.g., file, directory, metadata), network objects (network nodes or messages), user objects (e.g., user or group accounts), device objects (e.g., computers), other objects, or a combination thereof. The computing events may represent any action, occurrence, or result that relates to one or more of the computing objects. The computing events may indicate changes to computing objects (e.g., object updates), creation of computing objects (e.g., object generation), removal of computing objects (e.g., object deletion), other modification, or a combination thereof. Computing device 110 may receive data of the data set 120 from source 124.

Source 124 may include one or more sources that originate from one or more different devices or storage objects. Source 124 may provide data items 122 as a stream of data items that are received in a continuous or discrete manner. As the data items are received, they may be processed by computing device 110 and subsequently stored or discarded. Source 124 may also are alternatively be derived from a storage object such as a queue, log, journal, or other storage object. In one example, source 124 may be a database management system (DBMS) and the data items 122 may include database events that indicate values of one or more computing objects (e.g., database entries). In another example, source 124 may be a log and the data items 122 may be log entries that indicate modifications to a computing object. In yet another example, source 124 may be a network node and the data items 122 may include messages (e.g., network messages, email, SMS, RSS) that include values indicating header data (e.g., source, destination, intermediate nodes), body data (e.g., message content), other data, or a combination thereof. In any of these examples, computing device 110 may analyze data received from source 124 and update one or more of the probabilistic data structures 130A-C.

Probabilistic data structure 130A-C may be any combination of data structures that are capable of representing one or more properties of a set of data items. The properties may be of one or more sets or portions of a set (e.g., particular data items) and may relate to a size of the set (e.g., cardinality), a presence of an item in the set (e.g., set membership), one or more item quantities, an intersection between items or sets, one or more frequencies (e.g., frequency distribution), an inner product, quantiles, wavelets, histograms, other property, or a combination thereof. In one example, probabilistic data structure 130A-C may be based on or include one or more count-min sketches, bloom filters, hyperloglogs, locality-sensitive hashing, minhash, simhash, feature hash, cuckoo hashes, kinetic hanger, kinetic heater, quotient filter, random tree, random binary tree, rapidly-exploring random tree, skip list, treap, other probabilistic data structure, or a combination thereof.

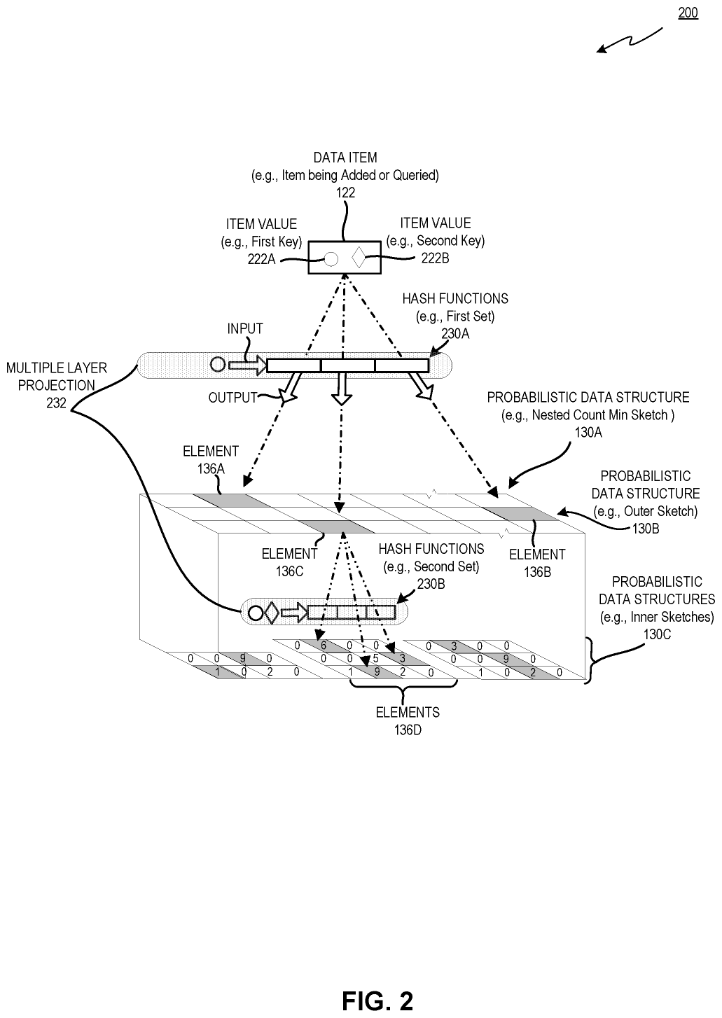

The probabilistic data structures may be evaluated using statistical methods. The statistical methods may involve one or more mathematical projections 132 (e.g., linear transformations) that map content of data items to portions of the one or more probabilistic data structures 130A-C. The statistical methods are discussed in more detail in regards to FIG. 2 and generally provide a tradeoff between storage space and accuracy. Generally, the less storage space available for the probabilistic data structure the less accurate the probabilistic data structure will represent the properties of the set. As a result, if the storage space remains constant and the set gets larger there may be a reduction in the accuracy of the results due to collisions. This may result in the probabilistic data structure incorrectly representing the number of data items in the set (e.g., overestimating count) or incorrectly indicating the presence of an item in the set (e.g., false positive), or other misrepresentation of a data set property.

Probabilistic data structure 130A may include one or more other probabilistic data structures and be referred to as nested probabilistic data structure. Probabilistic data structure 130A may also or alternatively be referred to as a hierarchical probabilistic data structure, a composite probabilistic data structure, an aggregate probabilistic data structure, other term, or a combination thereof. Probabilistic data structure 130A may include multiple probabilistic data structures (e.g., 130B-130C) that each have a plurality of elements. One or more of the elements 136 may include references 134 to other probabilistic data structures. In one example, each of the probabilistic data structures 130B-C may be arranged to have a two-dimensional arrangement (e.g., two-dimensional array or table) and the combination of the multiple probabilistic data structures may be organized in layers or levels that have a three-dimensional arrangement. As such, probabilistic data structure 130A may be a three-dimensional probabilistic data structure with a first dimension 131A (e.g., rows, x-axis), a second dimension 131B (columns, y-axis), and a third dimension 131C (e.g., layers, levels, z-axis).

As shown in FIG. 2, probabilistic data structure 130A may be a nested probabilistic data structure that includes probabilistic data structure 130B and one or more probabilistic data structures 130C. Probabilistic data structure 130B may function as an outer probabilistic data structure (e.g., top level) and may include elements that reference (e.g., link to) one or more probabilistic data structures 130C. The one or more probabilistic data structures 130C may function as inner probabilistic data structures (e.g., lower levels). One or more of the inner probabilistic data structure may also be a nested probabilistic data structure that includes elements that reference other probabilistic data structures or it may be a more traditional probabilistic data structure that includes elements with counter values or bit flags as (e.g., count-min sketch, bloom filter).

FIG. 2 illustrates an example method 200 for evaluating a nested probabilistic data structure using multiple layer projection 232, in accordance with an implementation of the disclosure. The evaluation of a nested probabilistic data structure may be used for adding a data item to the probabilistic data structure or for querying the probabilistic data structure to approximate one or more properties. Example method 200 is described using probabilistic data structures that are the same or similar to count-min sketches (CM sketches), but in other examples any other type of probabilistic data structure or a combination of different types of probabilistic data structures may be used (e.g., bloom filters, hyperloglogs, count-min sketches).

Multiple layer projection 232 may be used to evaluate a nested probabilistic data structure and identify the particular elements that correspond to a particular data item 122. Data item 122 may be a data item that computing device 110 is adding to the nested probabilistic data structure or a data item that computing device 110 is querying properties for. Data item 122 may include content in the form of a sequence of data values and may include multiple separate item values 222A and 222B. One or more of the item values 222A-B may include identification data (e.g., record identifier, item identifier, device identifier, network identifier), message data (e.g., characters, words, text), other data, or a combination thereof. Multiple layer projection 232 may use one or more of the item values 222A-B in combination with one or more sets of hash functions 230A and 230B to identify elements of nested probabilistic data structure 130A.

Each probabilistic data structure of the nested probabilistic data structure 130A may be implemented using one or more data storage structures. The data storage structures may include arrays, linked lists, tables, other data storage structures, or a combination thereof. Each data storage structure may include one or more elements (e.g., 136A-C) that may be referred to as entries, cells, or other term. Each element may be a data structure that includes an accumulator with one or more values. The one or more values may function as a pointer (e.g., one of references 134), a counter (e.g., integer), a binary state indicator (e.g. boolean value), other function, or a combination thereof. As shown in FIG. 2, elements 136A-C may include accumulators that each reference (e.g., point to or link to) a different inner probabilistic data structure and elements 136D may include accumulators that each function as counters (e.g., integer values). In one example, the probabilistic data structures 130B and 130C may be implemented using data storage structures that arrange the respective elements into a multidimensional arrangement (e.g., 2 or 3 dimensional table). One of the dimensions (e.g., rows) of each probabilistic data structure may correspond to a set of hash functions (e.g., 230A or 230B).

Hash functions 230A and 230B include hash functions that may be used to transform a sequence of bits that function as a key value (e.g., item value 222A or 222B) to a predefined quantity of bits referred to as a hash value. The same key value may be provided as input to some or all of the hash functions of a particular set. In the above example, probabilistic data structure 130B may correspond to hash functions 230A and probabilistic data structure 130C may correspond to hash functions 230B. Each row of a respective probabilistic data structure may correspond to a different hash function of the set, which is in contrast to a traditional hash table where all rows correspond to the same hash function. The output of the hash function may indicate a location of an element in the respective row. In one example, each of the hash functions in a set may be pairwise independent and be based on a set of random valuables in which at least two of the random variables are independent. The pairwise independent hash functions may or may not be mutually independent.

As shown in FIG. 2, the first set of hash functions 230A may include three separate hash functions that correspond to each of the three rows of probabilistic data structure 130B (e.g., outer sketch). Content of data item 122 (e.g., item value 222A) may serve as an input value (e.g., key) for each hash function in the set and result in a set of output values (e.g., hash value set). A first hash value (e.g., “2”) may correspond to element 136A, the second hash value (e.g., “7”) may correspond to element 136B and the third hash value (e.g., “3”) may correspond to element 136C. Each of the corresponding elements 136A-C may include a reference to a respective one of the probabilistic data structures 130C (e.g., inner sketches). For example, element 136C includes a reference to an inner probabilistic data structure that uses the second set of hash functions 230B. Other inner probabilistic data structures may have their own respective set of hash functions (not shown). The second set of hash functions 230B may be applied to content of data item 122 to identify the elements of the respective inner probabilistic data structure. In one example, the same content of data item 122 may be used as input for both the first and second sets of hash functions 230A-B. In another example, different content of data item 122 may be used as input for different sets of hash functions and item value 222A may be used as a key for the first set of hash functions 230A and both item values 222A and 222B may be used as a key for the second set of hash functions 230B. In either example, the multiple layer projection 232 may use the content of data item 122 to identify a set of elements.

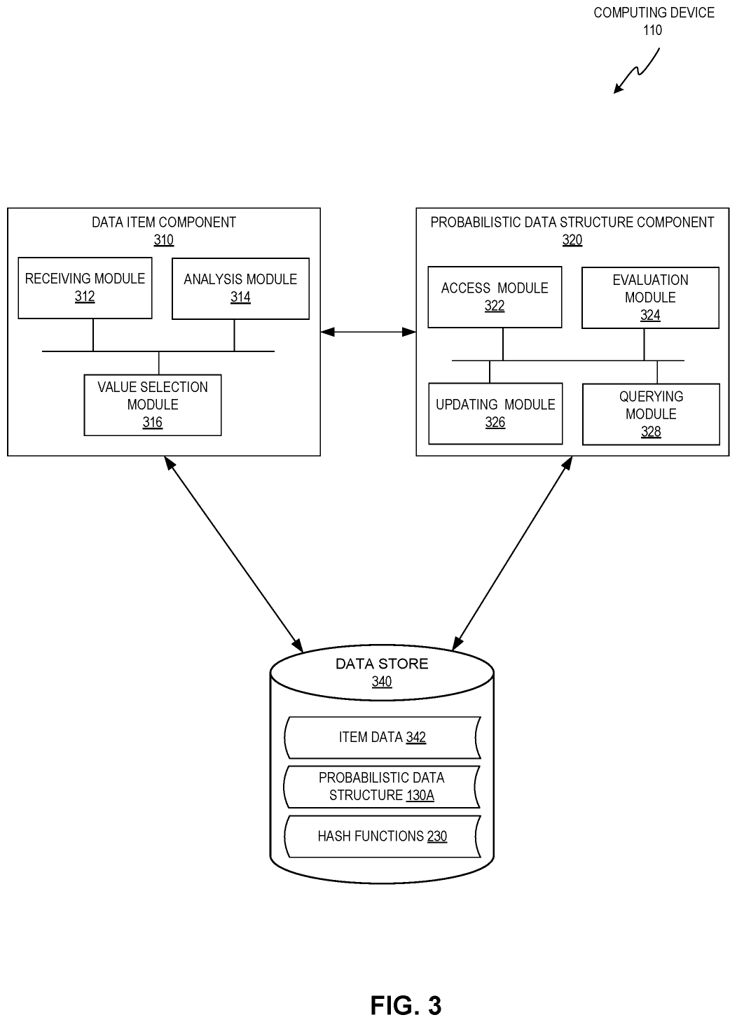

The set of elements may include particular elements of the probabilistic data structures that correspond to the particular data item 122. The set of elements may be referred to as an inner set or a set of inner elements and may correspond to multiple different inner probabilistic data structures. For example, the first layer projection may identify three elements in an outer sketch and each of those elements may correspond to an inner sketch. The second layer projection may identify multiple elements in each of the respective inner probabilistic data structures. Therefore, the set of inner elements may include the multiple elements of each respective inner probabilistic data structures. As shown in FIG. 2, the inner set may include 7 elements (e.g., 2+3+2=7 inner elements) that all correspond to data item 122. When multiple layers are involved, the set may include elements of probabilistic data structure at leaf positions and may span one or more levels (See FIG. 1). Now that the set of elements have been located, the elements may be analyzed or updated depending on whether we are adding or querying the nested probabilistic data structure. This is discussed in more detail in regards to module 326 and 328 of FIG. 3.

FIG. 3 illustrates an example computing device 110 in accordance with an implementation of the disclosure. As discussed above, computing device 110 may create and update a nested probabilistic data structure to represent a set of data items and may subsequently analyze the nested probabilistic data structure to determine properties related to the data items in the set. In the example shown in FIG. 3, computing device 110 may include a data item component 310 and a probabilistic data structure component 320. More or less components or modules may be included without loss of generality. For example, two or more of the components may be combined into a single component, or features of a component may be divided into two or more components. In one implementation, one or more of the modules or features may be executed by different computing devices (e.g., a first device performing the updating and a second device performing the querying).

Data item component 310 may enable computing device 110 to process incoming data items to determine which item values to use to add the data items to the nested probabilistic data structure. In one example, data item component 310 may include a receiving module 312, an analysis module 314, and a value selection module 316.

Receiving module 312 may include features to access content of one or more data items. The content of the data items may be a part of an existing set or may be individual or separate data items that computing device 110 subsequently adds to a set. Receiving module 312 may receive the data items from a source internal to computing device 110, from a source external to computing device 110, or a combination thereof. The external source may be accessible over a network and the network may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, and/or various combinations thereof.

Receiving module 312 may generate one or more requests to receive, retrieve, or access the data items. The request may be transmitted and processed internally by a portion of computing device 110 or may be transmitted externally over the network to a different computing device. The request may include identification data for determining one or more sources that provide the data items. In one example, the request may identify a particular storage object (e.g., database or file) that includes the data items. In another example, the request may identify a particular stream of data (e.g., a data feed, item stream, event stream) and may enable computing device 110 to listen or subscribe to the stream to receive the data items. In either example, the receiving module 312 may receive content of one or more data items and store the content as item data 342 so it can be processed by analysis module 314.

Analysis module 314 may analyze the item data 342 to determine which data items should be added to the probabilistic data structure. The analysis may involve analyzing the data of the data items and that may include data internal to the data item, data external to data item, or a combination thereof. The data internal to the data item may include the content within the data item and may include item identification data, body data, other data, or a combination thereof. Data external to the data item may include data corresponding to timing data (e.g., when data item was received or transmitted), source data (e.g., where the data item was received from), other data, or a combination thereof. Analysis module 314 may identify which data items to add to the set based on the internal data, external data, other data, or a combination thereof. Many data items may be received by receiving module 312 and analysis module may determine that some, all, or another portion of the data items should be added to the probabilistic data structure.

Value selection module 316 may select item values from a data item to use when adding the data items to the probabilistic data structure. As discussed above, each data item may include one or more item values. The item values may be any data of the data item and may be an item value extracted, aggregated, or derived from the content of the data item. The item values may include identification data, word data, other data, or a combination thereof. Value selection module 316 may extract a single item value or multiple item values from each data item. The multiple item values may be used to make a single addition to the probabilistic data structure or multiple different additions to the probabilistic data structure. In one example, data item 122 may include item values A and B and each item value may be used to make an addition to the nested probabilistic data structure (e.g., addition for key A and addition for key B). In another example, a data item may include item values X and Y and they may be used to make a single addition to the nested probabilistic data structure (addition for key X+Y).

Value selection module 316 and analysis module 314 may use one or more lists or rules to determine which item values or data items to add to the probabilistic data structure. The lists may be the same or similar to exclusion sets (e.g., black lists), inclusion sets (e.g., white lists), other list, or a combination thereof. Value selection module 316 may include rules for selecting values of data items at execution time (e.g., run time), initiation time (e.g., start time), other time, or a combination thereof. The rules may include logic for assessing a data item or an item value of the data item and may involve one or more comparisons of data internal or external to the data items. The rules may also or alternatively be used to identify and distinguish between item values within the data item. This may be the same or similar to item value demarcation, segmentation, tokenization, other process, or a combination thereof. In one example the rules may involve selecting any value over a threshold size (e.g., more than two characters) and may or may not exclude any predefined values (e.g., the word “the”).

The use of rules to identify item values may enable computing device 110 to identify and add item values that have not been predefined (e.g., predicates). Many traditional systems rely on a set of predefined keys and add content to the probabilistic data structure if the content matches the predefined keys. By using rules to identify item values, it enables computing device 110 to add item values that are not predefined and are unrecognized or unknown to the computing device prior to receiving or analyzing the data item. This may be particularly advantageous because the probabilistic data structure can be updated to represent item values encountered during execution that were unknown to the computing device when the computing devices was initiated, configured, or programed. In one example, a data item may comprise a plurality of unrecognized item values (e.g., words) and each of the unrecognized item values may be added to the nested probabilistic data structure using probabilistic data structure component 320.

Probabilistic data structure component 320 may access item data 342 and enable computing device 110 to update the probabilistic data structure 130 and query the probabilistic data structure 130. In one example, probabilistic data structure component 320 may include an access module 322, an evaluation module 324, an updating module 326, and a querying module 328.

Access module 322 may enable computing device 110 to access probabilistic data structure 130A and store it in data store 340. The probabilistic data structure 130 may be accessed from a location internal to the computing device 110, external to the computing device 110, or a combination thereof. As discussed above, the probabilistic data structure 130A may be a nested probabilistic data structure that includes multiple different secondary probabilistic data structures (e.g., inner probabilistic data structures). The nested probabilistic data structure may include multiple elements that each reference one of the secondary probabilistic data structures. The nested probabilistic data structure may have a hierarchical arrangement that includes multiple layers (e.g., multiple levels). The first layer may include a single outer probabilistic data structure (e.g., root probabilistic data structure) and the second layer may include a plurality of the secondary probability data structures. A portion of one or more of the probabilistic data structures may be located on the same computing device or on different computing devices. In one example, one or more of the probabilistic data structures may be a count-min sketch and the nested probabilistic data structure may be referred to as a three dimensional (3D) count-min sketch. In other examples, one or more of the probabilistic data structures may also or alternatively include bloom filters, hyperloglogs, other probabilistic data structure, or a combination thereof.

Evaluation module 324 may enable computing device 110 to evaluate probabilistic data structure 130 to identify a set of elements that correspond to the one or more item values of a particular data item. The process of evaluating the probabilistic data structure 130 is discussed in regards to FIG. 2 above and may involve performing multiple layer projection to identify a set of elements of the nested probabilistic data structure that correspond to the data item. The multiple layer projection may involve an iterative or recursive process that evaluates each of the multiple probabilistic data structures associated with the nested probabilistic data structure.

Each of the probabilistic data structures in the nested probabilistic data structure may be evaluated in view of a particular item value. Evaluation module 324 may access a set of hash functions associated with a particular probabilistic data structure being analyzed. In one example, each row (or column) may correspond to a particular hash function that is the same or different from a hash function of another row (or column). Evaluation module 324 may provide the particular item value as input to each of the set of hash functions to derive a set of output hash values. Evaluation module 324 may then use each hash value to identify an element within the respective row (or column) of a data storage structure (e.g., two-dimensional array). For example, the item value may be an identifier that functions as a key for each hash function and produces hash values 2, 9, and 3 respectively. The hash values may function as an index value for each respective row. Evaluation module 324 may then add element 2 of row 1, element 9 of row 2, and element 3 of row 3 to a set of elements that correspond to the data item.

The elements in the set may reference one or more other probabilistic data structures that can be evaluated to identify corresponding elements in those probabilistic data structures. The resulting set of elements may include elements from multiple probabilistic data structures. In one example, the set of elements may include elements that reference other probabilistic data structures. In another example, the set elements may be filtered, pruned, or modified to exclude elements that reference (e.g., link to) underlying probabilistic data structures. The filtered set of leaf elements may include the accumulators (e.g., counters, boolean flags) that are absent references to underlying probabilistic data structures. In either example, the set may be referred to as a set of inner elements and may identify the elements (e.g., counters, boolean flags) of the nested probabilistic data structure that correspond to a particular data item. The set of elements identified by evaluation module 324 may be used by updating module 326 or querying module 328.

Updating module 326 and querying module 328 may analyze probabilistic data structure 130A to add a data item or query information about the data item, respectively. As discussed above, the probabilistic data structure 130A (e.g., nested PDS) may include different types of probabilistic data structures (e.g., inner PDSs) such as count-min sketches, bloom filters, other probabilistic data structures, or a combination thereof. As a result, the set of elements may include elements from one or more of these different types of probabilistic data structures. For example, the elements that correspond to count-min sketches may include counting accumulators (e.g. integer values) whereas the elements that correspond to bloom filters may include accumulators that represent one of two states and may be referred to as binary accumulators (e.g., boolean values). As such, updating module 326 and querying module 328 may process the set of elements differently depending on the type of probabilistic data structure the elements are derived from.

Updating module 326 may enable computing device 110 to add a data item to the probabilistic data structure 130A. The elements that correspond to count-min sketches may include accumulators that function as counters and updating the elements to add a data item may comprise changing the value of the counter (e.g., incrementing or decrementing counter). The elements that correspond to bloom filters may include binary accumulators that represent one of two states and may include one or more bits. Binary accumulators may function as binary flags and updating the elements to add a data item may comprise changing (e.g., setting, flipping, or toggling) the value of the binary accumulator from an initial state (e.g., false, 0) to an activated state (e.g., true, 1+).

Querying module 328 may enable computing device 110 or a different computing device to query probabilistic data structure 130A to determine a property of the set. Querying module 328 may analyze the set of elements to determine a cardinality of a set, quantity of one or more data items in the set (e.g., frequency), quantile, wavelet, histogram, other property, or a combination thereof. Querying the probabilistic data structure for a property may involve applying one or more operations to the set of elements that correspond to the particular data item. The operations may include one or more logical operations (e.g., comparison, if-then), mathematical operations (e.g., arithmetic, statistical operations), other operations, or a combination thereof. In one example, the operations may include one or more of a minimum, maximum, median, mean, average, or other operation. When the elements correspond to a count-min sketch, the query may involve taking a minimum value of each element in the set of elements corresponding to the data item. When the elements correspond to a bloom filter, the query may involve comparing (e.g., checking) that each element in the set of elements indicates an active state (e.g., true value).

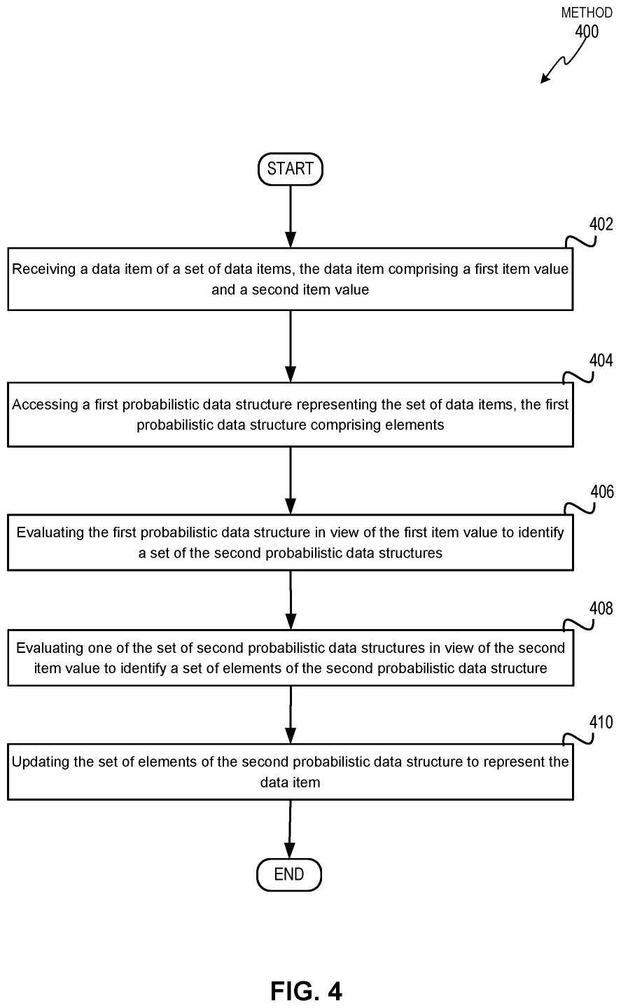

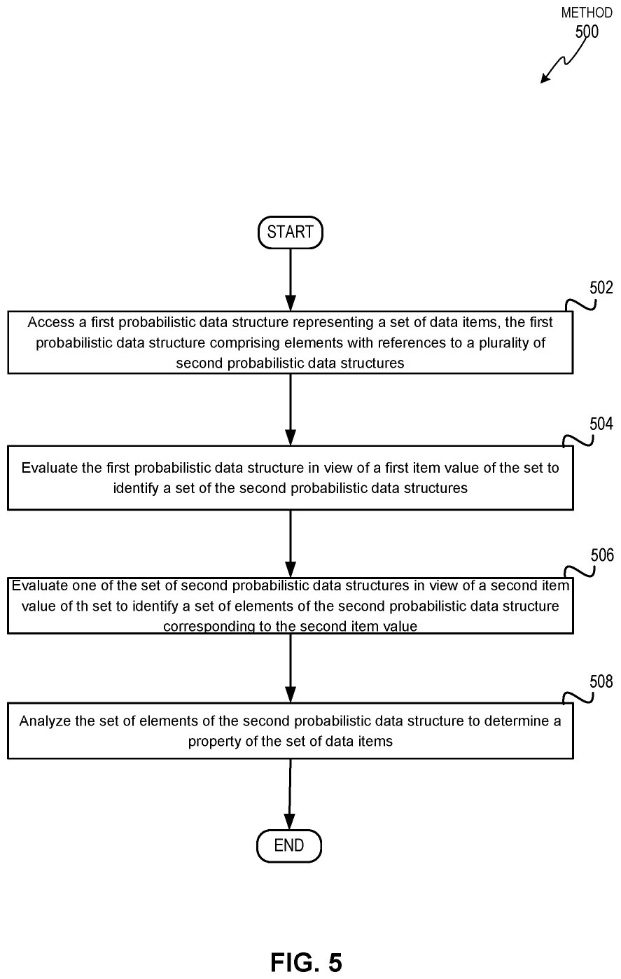

FIGS. 4 and 5 depict flow diagrams for illustrative examples of methods 400 and 500 for evaluating a nested probabilistic data structure. Method 400 illustrates an example process flow to add a data item to a nested probabilistic data structure and method 500 is an example process flow to query the nested probabilistic data structure to estimate a property for a data item. Methods 400 and 500 may be performed by processing devices that may comprise hardware (e.g., circuitry, dedicated logic, programmable logic, microcode, etc.), executable code (such as is run on a general purpose computer system or a dedicated machine), or a combination of both. Methods 400 and 500 and each of their individual functions, routines, subroutines, or operations may be performed by one or more processors of the computer device executing the method. In certain implementations, methods 400 and 500 may each be performed by a single device. Alternatively, methods 400 and 500 may be performed by two or more devices, each device executing one or more individual functions, routines, subroutines, or operations of the method.

For simplicity of explanation, the methods of this disclosure are depicted and described as a series of computing actions, acts, tasks, or steps. However, actions in accordance with this disclosure can occur in various orders and/or concurrently, and with other actions not presented and described herein. Furthermore, not all illustrated actions may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, methods 400 and 500 may be performed by data item component 310 and probabilistic data structure component 320 as shown in FIG. 3.

Referring to FIG. 4, method 400 may be performed by a processing device of a server device or a client device and may begin at block 402. At block 402, the processing device may receive a data item of a set of data items. Each of the data items may include multiple item values (e.g., a sequence of item values) that include a first item value, a second item value, and one or more other item values. The set of data items may be received as a stream of data items that include at least one of database events (e.g., added or modified database records), network messages (e.g., packets, segments, datagrams, frames), log entries, other items, or a combination thereof. One or more of the data items may include unrecognized item values and each of the unrecognized item values may be subsequently added to the nested probabilistic data structure. For example, a data item may include a plurality of words that are not predefined and each of the words can be segmented and added individually or in combination to the nested probabilistic data structure.

At block 404, the processing device may access a first probabilistic data structure that represents the set of data items. The first probabilistic data structure may include elements with references to a plurality of second probabilistic data structures. In one example, the first probabilistic data structure may be a nested probabilistic data structure and an element of the nested probabilistic data structure may reference (e.g., link to) one of the plurality of second probabilistic data structures. In another example, the first probabilistic data structure may be an outer probabilistic data structure (e.g., primary probabilistic data structure) and the second probabilistic data structures (e.g., secondary probabilistic data structures) may be inner probabilistic data structures. The outer and inner probabilistic data structures may collectively be referred to as the nested probability data structure or just the outer probabilistic data structure may be referred to as the nested probability data structure since it links to other probabilistic data structures. In either example, the second probabilistic data structures may include at least one of a count-min sketch, a bloom filter, or a hyperloglog.

The nested probabilistic data structure may include multiple layers of probabilistic data structures and each layer may include one or more probabilistic data structures. For example, the first layer may include the first probabilistic data structure (e.g., outer sketch) and the second layer may include the plurality of second probability data structures (e.g., inner sketches). The nested probabilistic data structure may include any number of layers and may be organized hierarchically with elements of a probabilistic data structure referencing a probabilistic data structure in a different layer (e.g., underlying lower layer). In one example, the nested probabilistic data structure may be a three dimensional (3D) count-min sketch that includes one or more layers that have two dimensional (2D) count-min sketches.

At block 406, the processing device may evaluate the first probabilistic data structure in view of the first item value to identify a set of the second probabilistic data structures. The evaluating may involve applying a set of hash functions to the first item value to generate hash values. Each of the hash functions may produce a hash value that indicates an element of the first probabilistic data structure and the element may include a reference to one of the second probabilistic data structures. Therefore, the set of hash values may indicate a set of second probabilistic data structures that correspond to the first item value.

At block 408, the processing device may evaluate one of the set of second probabilistic data structures in view of the second item value. The second item value may be from the same data item and may be the same or different from the first item value. In one example, the second item value may include the first item value (e.g., first item value is a word of a message and second item value is the entire message). In another example, the second item value may be separate from the first item value (e.g., first item is a first word and second item is a second word). In either example, the second item value may be used to identify a set of elements of the second probabilistic data structure that correspond to the second item value and therefore are associated with the data item.

At block 410, the processing device may update the set of elements of the second probabilistic data structure to represent the data item. In one example, the set of elements of the second probabilistic data structure may include a set of counters and updating the set of elements may involve incrementing each counter of the set of counters. Responsive to completing the operations described herein above with references to block 410, the method may terminate.

Other examples of method 400 may include a block related to querying the nested probabilistic data structure. Querying the nested probabilistic data structure may involve evaluating and analyzing the set of elements to approximate a property related to the set of data items. The property may be a mathematical property, a numeric property, a statistical property, algebraic property, other property, or a combination thereof and may include at least one of a frequency, a cardinality, an intersection, or a presence of a particular data item.

Referring to FIG. 5, method 500 may be performed by processing devices of a server device or a client device and may begin at block 502. At block 502, the processing device may access a first probabilistic data structure that represents the set of data items. The first probabilistic data structure may include elements with references to a plurality of second probabilistic data structures. In one example, the first probabilistic data structure may be a nested probabilistic data structure and an element of the nested probabilistic data structure may reference (e.g., link to) one of the plurality of second probabilistic data structures. In another example, the first probabilistic data structure may be an outer probabilistic data structure (e.g., primary probabilistic data structure) and the second probabilistic data structures (e.g., secondary probabilistic data structures) may be inner probabilistic data structures. The outer and inner probabilistic data structures may collectively be referred to as the nested probability data structure or just the outer probabilistic data structure may be referred to as the nested probability data structure since it links to other probabilistic data structures. In either example, the second probabilistic data structures may include at least one of a count-min sketch, a bloom filter, or a hyperloglog.

The nested probabilistic data structure may include multiple layers of probabilistic data structures and each layer may include one or more probabilistic data structures. For example, the first layer may include the first probabilistic data structure (e.g., outer sketch) and the second layer may include the plurality of second probability data structures (e.g., inner sketches). The nested probabilistic data structure may include any number of layers and may be organized hierarchically with elements of a probabilistic data structure referencing a probabilistic data structure in a different layer (e.g., underlying lower layer). In one example, the nested probabilistic data structure may be a three dimensional (3D) count-min sketch that includes one or more layers that have two dimensional (2D) count-min sketches.

At block 504, the processing device may evaluate the first probabilistic data structure in view of a first item value to identify a set of the second probabilistic data structures. The evaluating may involve applying a set of hash functions to the first item value to generate hash values. Each of the hash functions may produce a hash value that indicates an element of the first probabilistic data structure and the element may include a reference to one of the second probabilistic data structures. Therefore, the set of hash values may indicate a set of second probabilistic data structures that correspond to the first item value.

At block 506, the processing device may evaluate one of the set of second probabilistic data structures in view of a second item value. The second item value may be from the same data item and may be the same or different from the first item value. In one example, the second item value may include the first item value (e.g., first item value is a word of a message and second item value is the entire message). In another example, the second item value may be separate from the first item value (e.g., first item is a first word and second item is a second word). In either example, the second item value may be used to identify a set of elements of the second probabilistic data structure that correspond to the second item value and therefore are associated with the data item.

At block 508, the processing device may analyze the set of elements of the second probabilistic data structure to determine a property of the set of data item. The analysis may be part of querying the nested probabilistic data structure. Querying the nested probabilistic data structure may involve evaluating and analyzing the set of elements to approximate a property related to the set of data items. The property may be a mathematical property, a numeric property, a statistical property, algebraic property, other property, or a combination thereof and may include at least one of a frequency, a cardinality, an intersection, or a presence of a particular data item. Responsive to completing the operations described herein above with references to block 508, the method may terminate.

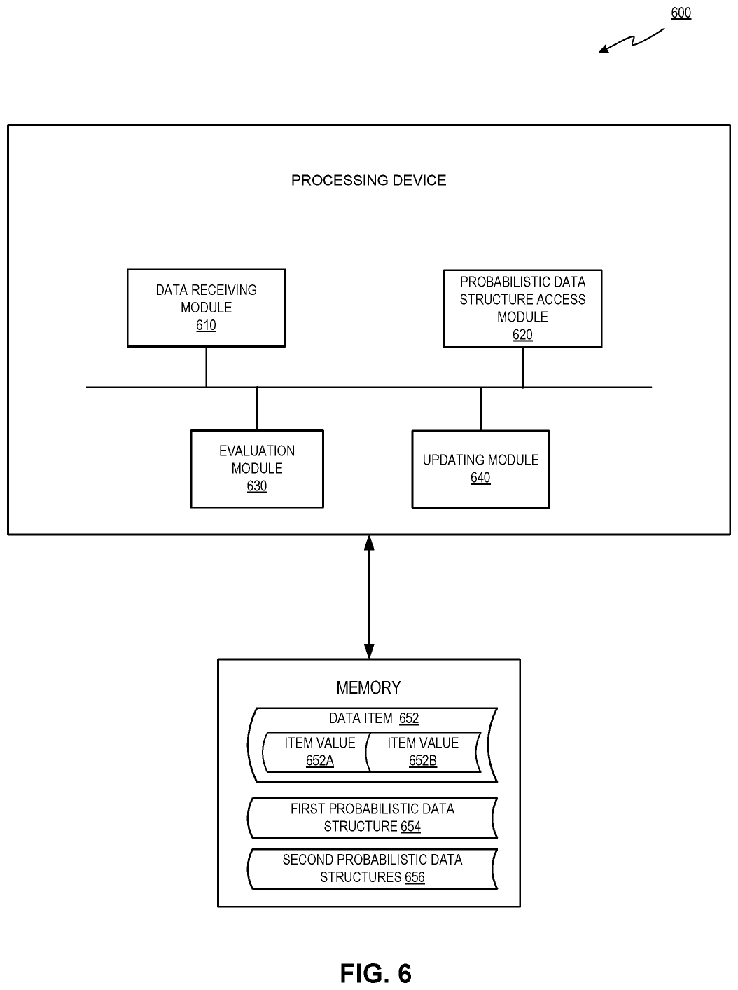

FIG. 6 depicts a block diagram of a computer system 600 operating in accordance with one or more aspects of the present disclosure. Computer system 600 may include one or more processing devices and one or more memory devices. In the example shown, computer system 600 may include a data receiving module 610, a probabilistic data structure access module 620, an evaluation module 630, and an updating module 640.

Data receiving module 610 may enable a processing device to receive a data item 652 of a set of data items. Each of the data items may include multiple item values (e.g., a sequence of item values) that include a first item value 652A, a second item value 652B, and one or more other item values. The set of data items may be received as a stream of data items that include at least one of database events (e.g., added or modified database records), network messages (e.g., packets, segments, datagrams, frames), log entries, other items, or a combination thereof. One or more of the data items may include unrecognized item values and each of the unrecognized item values may be subsequently added to the nested probabilistic data structure. For example, a data item may include a plurality of words that are not predefined and each of the words can be segmented and added individually or in combination to the nested probabilistic data structure.

Probabilistic data structure access module 620 may enable the processing device to access a first probabilistic data structure 654 that represents the set of data items. The first probabilistic data structure may include elements with references to a plurality of second probabilistic data structures 656. In one example, the first probabilistic data structure may be a nested probabilistic data structure and an element of the nested probabilistic data structure may reference (e.g., link to) one of the plurality of second probabilistic data structures. In another example, the first probabilistic data structure may be an outer probabilistic data structure (e.g., primary probabilistic data structure) and the second probabilistic data structures (e.g., secondary probabilistic data structures) may be inner probabilistic data structures. The outer and inner probabilistic data structures may collectively be referred to as the nested probability data structure or just the outer probabilistic data structure may be referred to as the nested probability data structure since it links to other probabilistic data structures. In either example, the second probabilistic data structures may include at least one of a count-min sketch, a bloom filter, or a hyperloglog.

The nested probabilistic data structure may include multiple layers of probabilistic data structures and each layer may include one or more probabilistic data structures. For example, the first layer may include the first probabilistic data structure (e.g., outer sketch) and the second layer may include the plurality of second probability data structures (e.g., inner sketches). The nested probabilistic data structure may include any number of layers and may be organized hierarchically with elements of a probabilistic data structure referencing a probabilistic data structure in a different layer (e.g., underlying lower layer). In one example, the nested probabilistic data structure may be a three dimensional (3D) count-min sketch that includes one or more layers that have two dimensional (2D) count-min sketches.

Evaluation module 630 may enable the processing device to evaluate the first probabilistic data structure in view of the first item value to identify a set of the second probabilistic data structures. The evaluating may involve applying a set of hash functions to the first item value to generate hash values. Each of the hash functions may produce a hash value that indicates an element of the first probabilistic data structure and the element may include a reference to one of the second probabilistic data structures. Therefore, the set of hash values may indicate a set of second probabilistic data structures that correspond to the first item value.

Evaluation module 630 may also enable the processing device to evaluate one of the set of second probabilistic data structures in view of the second item value. The second item value may be from the same data item and may be the same or different from the first item value. In one example, the second item value may include the first item value (e.g., first item value is a word of a message and second item value is the entire message). In another example, the second item value may be separate from the first item value (e.g., first item is a first word and second item is a second word). In either example, the second item value may be used to identify a set of elements of the second probabilistic data structure that correspond to the second item value and therefore are associated with the data item.

Updating module 640 may enable the processing device to update the set of elements of the second probabilistic data structure to represent the data item. In one example, the set of elements of the second probabilistic data structure may include a set of counters and updating the set of elements may involve incrementing each counter of the set of counters.

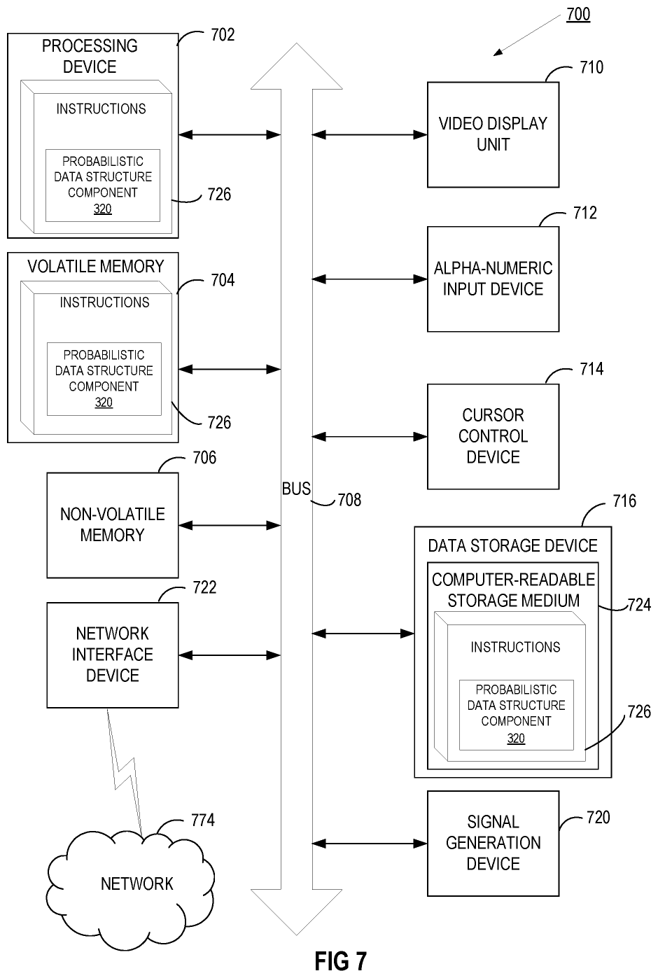

FIG. 7 depicts a block diagram of a computer system operating in accordance with one or more aspects of the present disclosure. In various illustrative examples, computer system 700 may correspond to computing device 110 of FIG. 1. Computer system 700 may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a computing device to translate these requests to the underlying physical computing hardware resources. This type of virtualization results in multiple VMs sharing physical resources.

In certain implementations, computer system 700 may be connected (e.g., via a network, such as a Local Area Network (LAN), an intranet, an extranet, or the Internet) to other computer systems. Computer system 700 may operate in the capacity of a server or a client computer in a client-server environment, or as a peer computer in a peer-to-peer or distributed network environment. Computer system 700 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 700 may include a processing device 702, a volatile memory 704 (e.g., random access memory (RAM)), a non-volatile memory 706 (e.g., read-only memory (ROM) or electrically-erasable programmable ROM (EEPROM)), and a data storage device 716, which may communicate with each other via a bus 708.

Processing device 702 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 700 may further include a network interface device 722. Computer system 700 also may include a video display unit 710 (e.g., an LCD), an alphanumeric input device 712 (e.g., a keyboard), a cursor control device 714 (e.g., a mouse), and a signal generation device 720.

Data storage device 716 may include a non-transitory computer-readable storage medium 724 on which may store instructions 726 encoding any one or more of the methods or functions described herein, including instructions for implementing methods 400 or 500 and for probabilistic data structure component 320 of FIG. 3.

Instructions 726 may also reside, completely or partially, within volatile memory 704 and/or within processing device 702 during execution thereof by computer system 700, hence, volatile memory 704 and processing device 702 may also constitute machine-readable storage media.

While computer-readable storage medium 724 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

Example 1 is a method comprising: receiving a data item of a set of data items, the data item comprising a first item value and a second item value; accessing a first probabilistic data structure representing the set of data items, the first probabilistic data structure comprising elements with references to a plurality of second probabilistic data structures; evaluating the first probabilistic data structure in view of the first item value to identify a set of the second probabilistic data structures, wherein the evaluating comprises applying a set of hash functions to the first item value to generate hash values indicating the set of second probabilistic data structures corresponding to the first item value; evaluating one of the set of second probabilistic data structures in view of the second item value to identify a set of elements of the second probabilistic data structure corresponding to the second item value; and updating the set of elements of the second probabilistic data structure to represent the data item.

Example 2 is the method of example 1, wherein the second probabilistic data structures comprise at least one of a count min sketch, a bloom filter, or a hyperloglog.

Example 3 is the method of example 1, wherein the first probabilistic data structure comprises a nested probabilistic data structure and an element of the nested probabilistic data structure references one of the plurality of second probabilistic data structures.

Example 4 is the method of example 3, wherein the nested probabilistic data structure comprises a first layer and a second layer, wherein the first layer comprises the first probabilistic data structure and wherein the second layer comprises the plurality of second probability data structures.

Example 5 is the method of example 3, wherein the nested probabilistic data structure comprises a three dimensional count-min sketch.

Example 6 is the method of example 3, further comprising querying the nested probabilistic data structure to approximate a property of the set, wherein the property of the set comprises at least one of a frequency, a cardinality, an intersection, or a presence of a particular data item.

Example 7 is the method of example 1, wherein the set of elements of the second probabilistic data structure comprise a set of counters, and wherein updating the set of elements comprises incrementing each counter of the set of counters.

Example 8 is the method of example 1, wherein the data item comprises a plurality of words that are not predefined, and wherein each of the words is added to the nested probabilistic data structure.

Example 9 is the method of example 1, wherein the set of data items comprise a stream of data items comprising at least one of database events, network messages, or log entries.

Example 10 is a system comprising: a memory; and a processing device operatively coupled to the memory, the processing device to: receive a data item of a set of data items, the data item comprising a first item value and a second item value; access a first probabilistic data structure representing the set of data items, the first probabilistic data structure comprising elements with references to a plurality of second probabilistic data structures; evaluate the first probabilistic data structure in view of the first item value to identify a set of the second probabilistic data structures, wherein the evaluating comprises applying a set of hash functions to the first item value to generate hash values indicating the set of second probabilistic data structures corresponding to the first item value; evaluate one of the set of second probabilistic data structures in view of the second item value to identify a set of elements of the second probabilistic data structure corresponding to the second item value; and update the set of elements of the second probabilistic data structure to represent the data item.

Example 11 is the system of example 10, wherein the second probabilistic data structures comprise at least one of a count min sketch, a bloom filter, or a hyperloglog.

Example 12 is the system of example 10, wherein the first probabilistic data structure comprises a nested probabilistic data structure and an element of the nested probabilistic data structure references one of the plurality of second probabilistic data structures.

Example 13 is the system of example 12, wherein the nested probabilistic data structure comprises a first layer and a second layer, wherein the first layer comprises the first probabilistic data structure and wherein the second layer comprises the plurality of second probability data structures.

Example 14 is the system of example 12, wherein the nested probabilistic data structure comprises a three dimensional count-min sketch.

Example 15 is a non-transitory machine-readable storage medium storing instructions that cause a processing device to: access a first probabilistic data structure representing a set of data items, the first probabilistic data structure comprising elements with references to a plurality of second probabilistic data structures; evaluate the first probabilistic data structure in view of a first item value of the set to identify a set of the second probabilistic data structures, wherein the evaluating comprises applying a set of hash functions to the first item value to generate hash values indicating the set of second probabilistic data structures corresponding to the first item value; evaluate one of the set of second probabilistic data structures in view of a second item value of th set to identify a set of elements of the second probabilistic data structure corresponding to the second item value; and analyze the set of elements of the second probabilistic data structure to determine a property of the set of data items.

Example 16 is the non-transitory machine-readable storage medium of example 15, wherein the second probabilistic data structures comprise at least one of a count min sketch, a bloom filter, or a hyperloglog.

Example 17 is the non-transitory machine-readable storage medium of example 15, wherein the first probabilistic data structure comprises a nested probabilistic data structure and an element of the nested probabilistic data structure references one of the plurality of second probabilistic data structures.

Example 18 is the non-transitory machine-readable storage medium of example 17, wherein the nested probabilistic data structure comprises a first layer and a second layer, wherein the first layer comprises the first probabilistic data structure and the second layer comprises the plurality of second probability data structures.

Example 19 is the non-transitory machine-readable storage medium of example 17, wherein the nested probabilistic data structure comprises a three dimensional count-min sketch.

Example 20 is the non-transitory machine-readable storage medium of example 15, wherein the set of data items comprise a stream of data items comprising at least one of database events, network messages, or log entries.

Example 21 is a method comprising: accessing a first probabilistic data structure representing a set of data items, the first probabilistic data structure comprising elements with references to a plurality of second probabilistic data structures; evaluating the first probabilistic data structure in view of a first item value of the set to identify a set of the second probabilistic data structures, wherein the evaluating comprises applying a set of hash functions to the first item value to generate hash values indicating the set of second probabilistic data structures corresponding to the first item value; evaluating one of the set of second probabilistic data structures in view of a second item value of th set to identify a set of elements of the second probabilistic data structure corresponding to the second item value; and analyzing the set of elements of the second probabilistic data structure to determine a property of the set of data items.

Example 22 is the method of example 21, wherein the second probabilistic data structures comprise at least one of a count min sketch, a bloom filter, or a hyperloglog.

Example 23 is the method of example 21, wherein the first probabilistic data structure comprises a nested probabilistic data structure and an element of the nested probabilistic data structure references one of the plurality of second probabilistic data structures.

Example 24 is the method of example 23, wherein the nested probabilistic data structure comprises a first layer and a second layer, wherein the first layer comprises the first probabilistic data structure and the second layer comprises the plurality of second probability data structures.

Example 25 is the method of example 23, wherein the nested probabilistic data structure comprises a three dimensional count-min sketch.

Example 26 is an apparatus comprising: means to receive a data item of a set of data items, the data item comprising a first item value and a second item value; means to access a first probabilistic data structure representing the set of data items, the first probabilistic data structure comprising elements with references to a plurality of second probabilistic data structures; means to evaluate the first probabilistic data structure in view of the first item value to identify a set of the second probabilistic data structures, wherein the evaluating comprises applying a set of hash functions to the first item value to generate hash values indicating the set of second probabilistic data structures corresponding to the first item value; means to evaluate one of the set of second probabilistic data structures in view of the second item value to identify a set of elements of the second probabilistic data structure corresponding to the second item value; and means to update the set of elements of the second probabilistic data structure to represent the data item.

Example 27 is the apparatus of example 25, wherein the second probabilistic data structures comprise at least one of a count min sketch, a bloom filter, or a hyperloglog.

Example 28 is the apparatus of example 25, wherein the first probabilistic data structure comprises a nested probabilistic data structure and an element of the nested probabilistic data structure references one of the plurality of second probabilistic data structures.

Example 29 is the apparatus of example 28, wherein the nested probabilistic data structure comprises a first layer and a second layer, wherein the first layer comprises the first probabilistic data structure and wherein the second layer comprises the plurality of second probability data structures.

Example 30 is the apparatus of example 28, wherein the nested probabilistic data structure comprises a three dimensional count-min sketch.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “determining,” “transmitting,” “providing,” “establishing,” “receiving,” “identifying,” “obtaining,” “initiating,” “accessing,” “detecting,” “generating,” “creating,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 400, 500 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
receiving a data item of a set of data items, the data item comprising a first item value and a second item value;
accessing a first probabilistic data structure representing the set of data items, the first probabilistic data structure comprising elements with references to a plurality of second probabilistic data structures;
evaluating the first probabilistic data structure in view of the first item value to identify a set of the second probabilistic data structures, wherein the evaluating comprises applying a set of hash functions to the first item value to generate hash values indicating the set of second probabilistic data structures corresponding to the first item value;
evaluating one of the set of second probabilistic data structures in view of the second item value to identify a set of elements of the second probabilistic data structure corresponding to the second item value; and
updating the set of elements of the second probabilistic data structure to represent the data item.

2. The method of claim 1, wherein the second probabilistic data structures comprise at least one of a count min sketch, a bloom filter, or a hyperloglog.

3. The method of claim 1, wherein the first probabilistic data structure comprises a nested probabilistic data structure and an element of the nested probabilistic data structure references one of the plurality of second probabilistic data structures.

4. The method of claim 3, wherein the nested probabilistic data structure comprises a first layer and a second layer, wherein the first layer comprises the first probabilistic data structure and wherein the second layer comprises the plurality of second probability data structures.

5. The method of claim 3, wherein the nested probabilistic data structure comprises a three dimensional count-min sketch.

6. The method of claim 3, further comprising querying the nested probabilistic data structure to approximate a property of the set, wherein the property of the set comprises at least one of a frequency, a cardinality, an intersection, or a presence of a particular data item.

7. The method of claim 1, wherein the set of elements of the second probabilistic data structure comprise a set of counters, and wherein updating the set of elements comprises incrementing each counter of the set of counters.

8. The method of claim 1, wherein the data item comprises a plurality of words that are not predefined, and wherein each of the words is added to the nested probabilistic data structure.

9. The method of claim 1, wherein the set of data items comprise a stream of data items comprising at least one of database events, network messages, or log entries.

10. A system comprising:
a memory; and
a processing device operatively coupled to the memory, the processing device to:
receive a data item of a set of data items, the data item comprising a first item value and a second item value;
access a first probabilistic data structure representing the set of data items, the first probabilistic data structure comprising elements with references to a plurality of second probabilistic data structures;
evaluate the first probabilistic data structure in view of the first item value to identify a set of the second probabilistic data structures, wherein the evaluating comprises applying a set of hash functions to the first item value to generate hash values indicating the set of second probabilistic data structures corresponding to the first item value;
evaluate one of the set of second probabilistic data structures in view of the second item value to identify a set of elements of the second probabilistic data structure corresponding to the second item value; and
update the set of elements of the second probabilistic data structure to represent the data item.

11. The system of claim 10, wherein the second probabilistic data structures comprise at least one of a count min sketch, a bloom filter, or a hyperloglog.

12. The system of claim 10, wherein the first probabilistic data structure comprises a nested probabilistic data structure and an element of the nested probabilistic data structure references one of the plurality of second probabilistic data structures.

13. The system of claim 12, wherein the nested probabilistic data structure comprises a first layer and a second layer, wherein the first layer comprises the first probabilistic data structure and wherein the second layer comprises the plurality of second probability data structures.

14. The system of claim 12, wherein the nested probabilistic data structure comprises a three dimensional count-min sketch.

15. A non-transitory machine-readable storage medium storing instructions that cause a processing device to:
access a first probabilistic data structure representing a set of data items, the first probabilistic data structure comprising elements with references to a plurality of second probabilistic data structures;
evaluate the first probabilistic data structure in view of a first item value of the set to identify a set of the second probabilistic data structures, wherein the evaluating comprises applying a set of hash functions to the first item value to generate hash values indicating the set of second probabilistic data structures corresponding to the first item value;
evaluate one of the set of second probabilistic data structures in view of a second item value of th set to identify a set of elements of the second probabilistic data structure corresponding to the second item value; and
analyze the set of elements of the second probabilistic data structure to determine a property of the set of data items.

16. The non-transitory machine-readable storage medium of claim 15, wherein the second probabilistic data structures comprise at least one of a count min sketch, a bloom filter, or a hyperloglog.

17. The non-transitory machine-readable storage medium of claim 15, wherein the first probabilistic data structure comprises a nested probabilistic data structure and an element of the nested probabilistic data structure references one of the plurality of second probabilistic data structures.

18. The non-transitory machine-readable storage medium of claim 17, wherein the nested probabilistic data structure comprises a first layer and a second layer, wherein the first layer comprises the first probabilistic data structure and the second layer comprises the plurality of second probability data structures.

19. The non-transitory machine-readable storage medium of claim 17, wherein the nested probabilistic data structure comprises a three dimensional count-min sketch.

20. The non-transitory machine-readable storage medium of claim 15, wherein the set of data items comprise a stream of data items comprising at least one of database events, network messages, or log entries.

21. A method comprising:
accessing a first probabilistic data structure representing a set of data items, the first probabilistic data structure comprising elements with references to a plurality of second probabilistic data structures;
evaluating the first probabilistic data structure in view of a first item value of the set to identify a set of the second probabilistic data structures, wherein the evaluating comprises applying a set of hash functions to the first item value to generate hash values indicating the set of second probabilistic data structures corresponding to the first item value;
evaluating one of the set of second probabilistic data structures in view of a second item value of th set to identify a set of elements of the second probabilistic data structure corresponding to the second item value; and
analyzing the set of elements of the second probabilistic data structure to determine a property of the set of data items.

22. The method of claim 21, wherein the second probabilistic data structures comprise at least one of a count min sketch, a bloom filter, or a hyperloglog.

23. The method of claim 21, wherein the first probabilistic data structure comprises a nested probabilistic data structure and an element of the nested probabilistic data structure references one of the plurality of second probabilistic data structures.

24. The method of claim 23, wherein the nested probabilistic data structure comprises a first layer and a second layer, wherein the first layer comprises the first probabilistic data structure and the second layer comprises the plurality of second probability data structures.

25. The method of claim 23, wherein the nested probabilistic data structure comprises a three dimensional count-min sketch.

26. An apparatus comprising:
means to receive a data item of a set of data items, the data item comprising a first item value and a second item value;
means to access a first probabilistic data structure representing the set of data items, the first probabilistic data structure comprising elements with references to a plurality of second probabilistic data structures;
means to evaluate the first probabilistic data structure in view of the first item value to identify a set of the second probabilistic data structures, wherein the evaluating comprises applying a set of hash functions to the first item value to generate hash values indicating the set of second probabilistic data structures corresponding to the first item value;
means to evaluate one of the set of second probabilistic data structures in view of the second item value to identify a set of elements of the second probabilistic data structure corresponding to the second item value; and
means to update the set of elements of the second probabilistic data structure to represent the data item.

27. The apparatus of claim 25, wherein the second probabilistic data structures comprise at least one of a count min sketch, a bloom filter, or a hyperloglog.

28. The apparatus of claim 25, wherein the first probabilistic data structure comprises a nested probabilistic data structure and an element of the nested probabilistic data structure references one of the plurality of second probabilistic data structures.

29. The apparatus of claim 28, wherein the nested probabilistic data structure comprises a first layer and a second layer, wherein the first layer comprises the first probabilistic data structure and wherein the second layer comprises the plurality of second probability data structures.

30. The apparatus of claim 28, wherein the nested probabilistic data structure comprises a three dimensional count-min sketch.
